(19) United States
(12) Patent Application Publication
(10) Pub. No.: US 2009/0064017 A1
(43) Pub. Date: Mar. 5, 2009

(54) TUNING/CUSTOMIZATION

(75) Inventors: Bryan Biniak, Los Angeles, CA (US); Chris Cunningham, Los Angeles, CA (US); Atanas Ivanov, Santa Monica, CA (US); Jeffrey Marks, Sherman oaks, CA (US); Brock Meltzer, Los Angeles, CA (US)

Correspondence Address: DLA PIPER US LLP, 1999 AVENUE OF THE STARS, SUITE 400, LOS ANGELES, CA, 90067-6023, US

(73) Assignee: JACKED, INC., SANTA MONICA, CA (US)

(21) Appl. No.: 12/203,122

(22) Filed: Sep. 2, 2008

Related U.S. Application Data
(60) Provisional application No. 60/969,455, filed on Aug. 31, 2007.

(51) Int. Cl. G06F 3/048

(52) U.S. Cl. 715/764

(57) ABSTRACT

The system provides the ability to have a dashboard automatically configure itself in a dynamic manner based on a detected context in which the dashboard is being used. In one embodiment, the system is used as part of the presentation of secondary content that is synchronized to, or coordinated with, the presentation of a primary content source. The system provides a plurality of user selectable widgets that can each present secondary content as desired. The system not only permits ornamental and geographical customization of the dashboard, but allows temporal customization as well by allowing the user to request alerts for certain types of primary or secondary content. The system also provides for automatic reconfiguration that is tied to another users presence or absence.

This patent application claims priority to United States Provisional Patent application No. 60/969,455 filed on Aug. 31, 2007 and entitled “Tuning/Customization” which is incorporated by reference herein in its entirety.

### BACKGROUND OF THE SYSTEM

A number of computer applications describe a user environment as a “dashboard”. The dashboard represents the displays, tools, icons, applications, and other functions, features, and ornamentation that comprise a display user environment. Often the dashboard look and feel can be customized for one or more specific users. In addition, the dashboard can sometimes be customized by any one user by arranging the screen elements in a desired configuration, by choosing or eliminating certain elements, or by changing the color or graphic scheme of the display.

A disadvantage of current systems is the lack of a dynamic or automatic customization of the display and the lack of ability to have a plurality of customizable representations for each user.

### SUMMARY OF THE SYSTEM

The system provides the ability to have a dashboard automatically configure itself in a dynamic manner based on a detected context in which the dashboard is being used. In one embodiment, the system is used as part of the presentation of secondary content that is synchronized to, or coordinated with, the presentation of a primary content source. The system provides a plurality of user selectable widgets that can each present secondary content as desired. The system not only permits ornamental and geographical customization of the dashboard, but allows temporal customization as well by allowing the user to request alerts for certain types of primary or secondary content. The system also provides for automatic reconfiguration that is tied to another users presence or absence.

### BRIEF DESCRIPTION OF THE DRAWINGS

FIG. 1 illustrates the high level flow of information and content through the Social Media Platform;

FIG. 2 illustrates the content flow and the creation of generative media via a Social Media Platform;

FIG. 3 illustrates the detailed platform architecture components of the Social Media Platform for creation of generative media and parallel programming shown in FIG. 2; and

FIGS. 4-6 illustrate an example of the user interface for an implementation of the Social Media Platform and the Parallel Programming experience.

FIG. 7 is an example of a dashboard in an embodiment of the system.

FIG. 8 is a flow diagram illustrating operation of the video widget in a trigger based environment.

FIG. 9 is a flow diagram illustrating the operation of contextual widgets.

FIG. 10 is an example computer environment for implementing the system in one embodiment.

FIG. 11 is a flow diagram illustrating the modification of update rates pursuant to an embodiment of the system.

FIG. 12 is a flow diagram illustrating the operation of alerts in one embodiment of the system.

FIG. 13 is a block diagram of one embodiment of a template structure of the system.

### DETAILED DESCRIPTION OF THE SYSTEM

The present system provides a method for collecting and displaying context relevant content generated by users, found through searches, or is licensed content. In the following description, numerous specific details are set forth to provide a more thorough description of the system. It will be apparent, however, that the system may be practiced without these specific details. In other instances, well know features have not been described in detail.

Social Media Platform

In one embodiment, the invention is particularly applicable to a Social Media Platform in which the source of the original content is a broadcast television signal and it is in this context that the invention will be described. It will be appreciated, however, that the system and method has greater utility since it can be used with a plurality of different types of original source content.

The ecosystem of the Social Media Platform may include primary sources of media, generative media, participatory media, generative programming, parallel programming, and accessory devices. The Social Media Platform uses the different sources of original content to create generative media, which is made available through generative programming and parallel programming (when published in parallel with the primary source of original content). The generative media may be any media connected to a network that is generated based on the media coming from the primary sources. The generative programming is the way the generative media is exposed for consumption by an internal or external system. The parallel programming is achieved when the generative programming is contextually synchronized and published in parallel with the transmitted media (source of original content). The participatory media means that third parties can produce generative media, which can be contextually linked and tuned with the transmitted media. The accessory devices of the Social Media Platform and the parallel programming experience may include desktop or laptop PCs, mobile phones, PDAs, wireless email devices, handheld gaming units and/of PocketPCs that are the new remote controls.

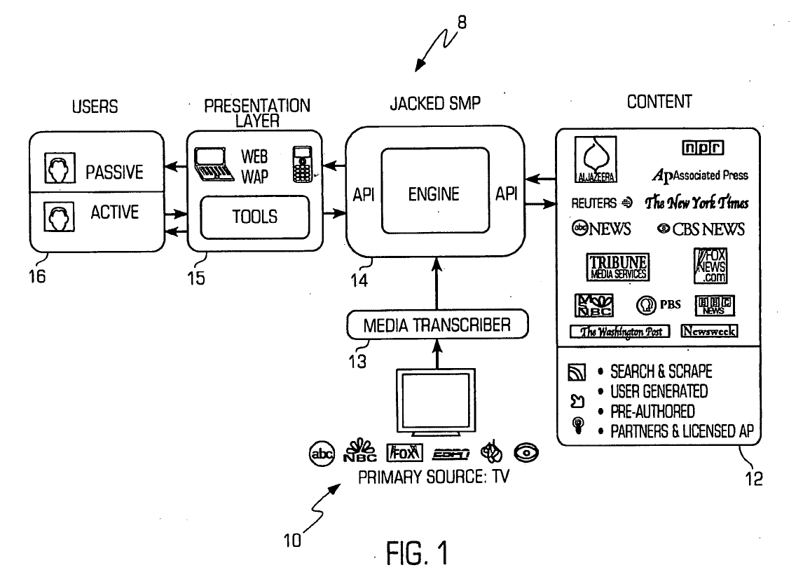

FIG. 1 illustrates the high level flow of information and content through the Social Media Platform 8. The platform may include an original content source 10, such as a television broadcast, with a contextual secondary content source 12, that contains different content wherein the content from the original content source is synchronized with the content from the contextual content source so that the user views the original content source while being provided with the additional content contextually relevant to the original content.

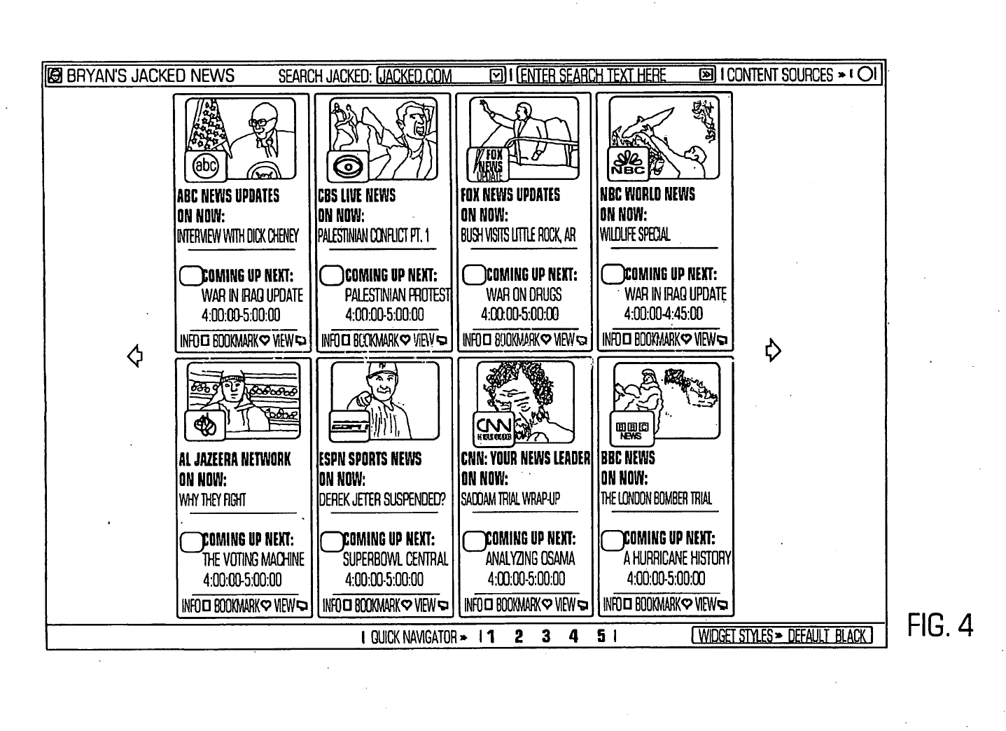

The contextual content source 12 may include different types of contextual media including text, images, audio, video, advertising, commerce (purchasing) as well as third party content such as publisher content (such as Time, Inc., XML), web content, consumer content, advertiser content and retail content. An example of an embodiment of the user interface of the contextual content source is described below with reference to FIGS. 4-6. The contextual content source 12 may be generated/provided using various techniques such as search and scrape, user generated, pre-authored and partner and licensed material.

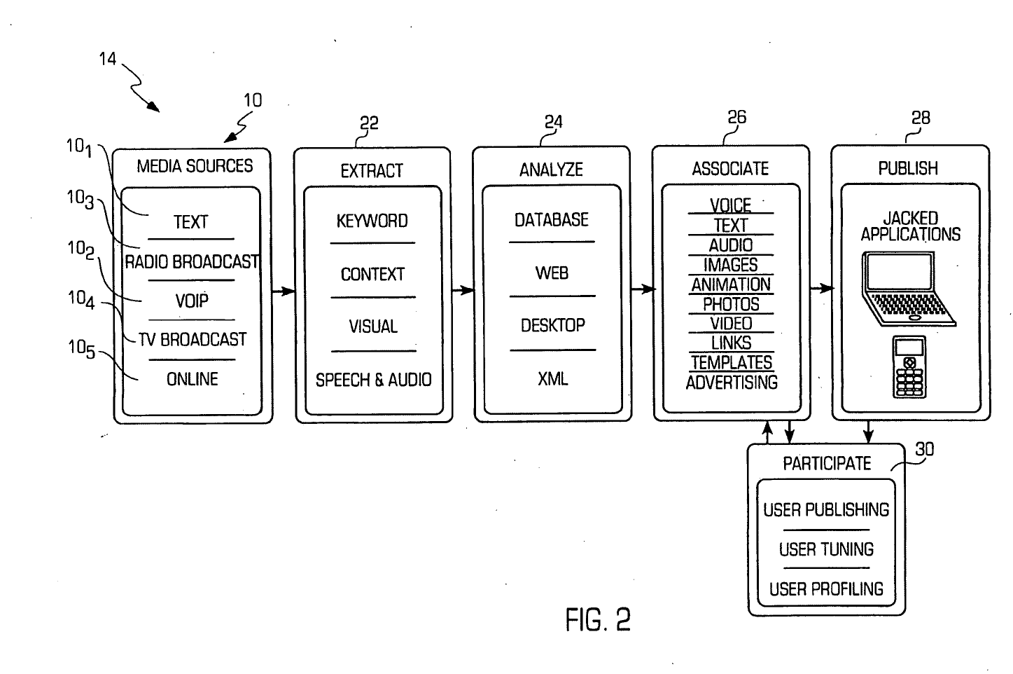

The original/primary content source 10 is fed into a media transcriber 13 (or extractor 22 of FIG. 2) that extracts information from the original content source which is fed into a social media platform 14 (or associate block 26 and participate block 30 of FIG. 2). The Social Media Platform 14 at that point extracts, analyzes, and associates the Generative Media (shown in more detail in FIG. 2) with content from various sources. Contextually relevant content is then published via a presentation layer 15 to end users 16 wherein the end users may be passive and/or active users. The passive users will view the original content in synchronization with the contextual content while the active users will use tools made accessible to the user to tune content, create and publish widgets, and create and publish dashboards. The users may use one device to view both the original content and the contextual content (such as television in one embodiment) or use different devices to view the original content and the contextual content (such as on a web page as shown in the examples below of the user interface). The API associates and maps the secondary content and participatory content to the appropriate primary source and makes it available to the presentation layer (within the appropriate context that the user has chosen to view, e.g. Team photos mapped to Monday Night Football and crime scene photos mapped to CSI).

The social media platform uses linear broadcast programming (the original content) to generate participative, parallel programming (the contextual/secondary content) wherein the original content and secondary content may be synchronized and delivered to the user. The social media platform enables viewers to jack-in to broadcasts to tune and publish their own content. The social media platform also extends the reach of advertising and integrates communication, community and commerce together.

FIG. 2 illustrates content flow and creation of generative media via a Social Media Platform 14. The system 14 accesses the original content source 10 and the contextual/secondary content source 12 shown in FIG. 1. As shown in FIG. 2, the original content source 10 may include, but is not limited to, a text source 10₁, such as Instant Messaging (IM), SMS, a blog or an email, a voice over IP source 10₂, a radio broadcast source 10₃, a television broadcast source 10₄ or a online broadcast source 10₅, such as a streamed broadcast. Other types of original content sources may also be used (even those yet to be developed original content sources) and those other original content sources are within the scope of the invention since the invention can be used with any original content source as will be understood by one of ordinary skill in the art. The original content may be transmitted to a user over various medium, such as over a cable, and displayed on various devices, such as a television attached to the cable, since the system is not limited to any particular transmission medium or display device for the original content. The secondary source 12 may be used to-create contextually relevant generative content that is transmitted to and displayed on a device 28 wherein the device may be any processing unit based device with sufficient processing power, memory and connectivity to receive the contextual content. For example, the device 28 may be a personal computer or a mobile phone (as shown in FIG. 2), but the device may also be PDAs, laptops, wireless email devices, handheld gaming units and/or PocketPCs. The invention is also not limited to any particular device on which the contextual content is displayed.

The social media platform 14, in this embodiment, may be a computer implemented system that has one or more units (on the same computer resources such as servers or spread across a plurality of computer resources) that provide the functionality of the system wherein each unit may have a plurality of lines of computer code executed by the computer resource on which the unit is located that implement the processes and steps and functions described below in more detail. The social media platform 14 may capture data from the original content source and analyze the captured data to determine the context/subject matter of the original content, associate the data with one or more pieces of contextual data that is relevant to the original content based on the determined context/subject matter of the original content and provide the one or more pieces of contextual data to the user synchronized with the original content. The social media platform 14 may include an extract unit 22 that performs extraction functions and steps, an analyze unit 24 that performs an analysis of the extracted data from the original source, an associate unit 26 that associates contextual content with the original content based on the analysis, a publishing unit 28 that publishes the contextual content in synchronism with the original content and a participatory unit 30.

The extraction unit 22 captures the digital data from the original content source 10 and extracts or determines information about the original content based on an analysis of the original content. The analysis may occur through keyword analysis, context analysis, visual analysis and speech/audio recognition analysis. For example, the digital data from the original content may include close captioning information or metadata associated with the original content that can be analyzed for keywords and context to determine the subject matter of the original content. As another example, the image information in the original content can be analyzed by a computer, such as by video optical character recognition to text conversion, to generate information about the subject matter of the original content. Similarly, the audio portion of the original content can be converted using speech/audio recognition to obtain textual representation of the audio. The extracted closed captioning and other textual data is fed to an analysis component which is responsible for extracting the topic and the meaning of the context. The extract unit 22 may also include a screening/relevancy mechanism to address an absence or lack of close caption data in the original content and/or a mechanism for addressing too much data that may be known as “informational noise.” The screening mechanism can include the mapping of keywords and/or keyword groups or concepts to determine relevance of the close caption data with respect to the related domain of content programming. Furthermore, the screening mechanism will strike out keywords and concepts which have been previously determined to be of low relevance to the domain by either empirical performance by consumers, editorial feedback and or strikelisted content.

Once the keywords/subject matter/concepts of the original content is determined, that information is fed into the analyze unit 24 which may include a contextual search unit. The analysis unit 24 may perform one or more searches, such as database searches, web searches, desktop searches and/or XML searches, to identify contextual content in real time that is relevant to the particular subject matter of the original content at the particular time. The resultant contextual content, also called generative media, is then fed into the association unit 26 which generates the real-time contextual data for the original content at that particular time. As shown in FIG. 2, the contextual data may include, for example, voice data, text data, audio data, image data, animation data, photos, video data, links and hyperlinks, templates and/or advertising.

The participatory unit 30 may be used to add other third party/user contextual data into the association unit 26. The participatory contextual data may include user publishing information (information/content generated by the user or a third party), user tuning (permitting the user to tune the contextual data sent to the user) and user profiling (that permits the user to create a profile that will affect the contextual data sent to the user). An example of the user publishing information may be a voiceover of the user which is then played over the muted original content. For example, a user who is a baseball fan might do the play-by-play for a game and then play his play-by-play while the game is being played wherein the audio of the original announcer is muted which may be known as fan casting.

The publishing unit 28 may receive data from the association unit 26 and interact with the participatory unit 30. The publishing unit 28 may publish the contextual data into one or more formats that may include, for example, a proprietary application format, a PC format (including for example a website, a widget, a toolbar, an IM plug-in or a media player plug-in) or a mobile device format (including for example WAP format, JAVA format or the BREW format). The formatted contextual data is then provided, in real time and in synchronization with the original content, to the devices 16 that display the contextual content.

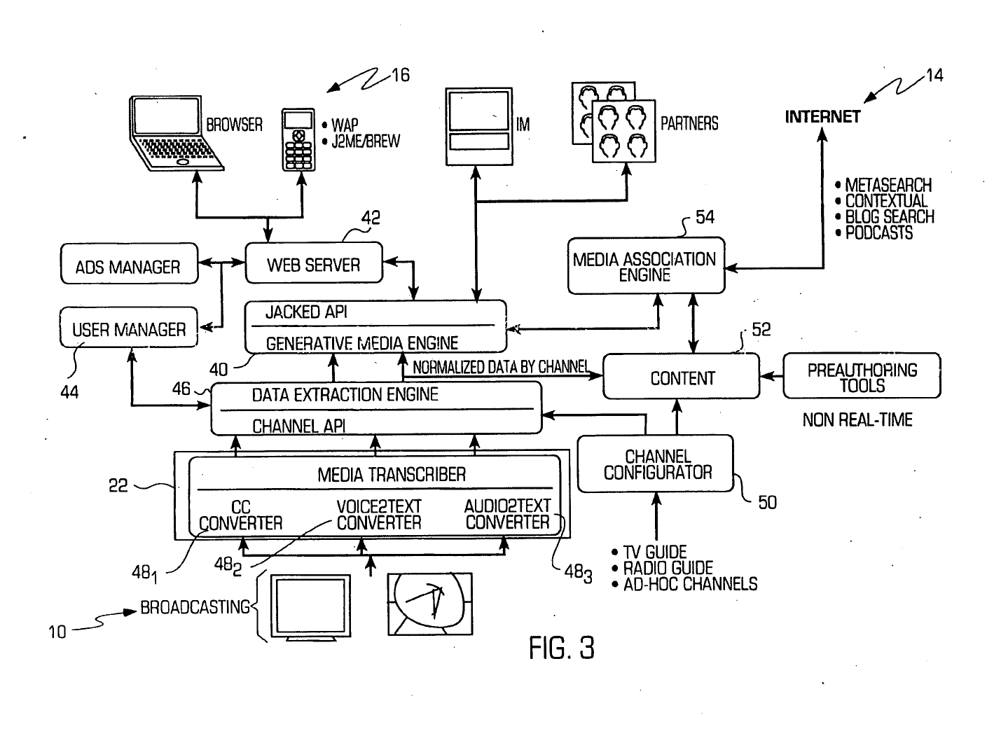

FIG. 3 illustrates more details of the Social Media Platform for creation of generative media and parallel programming shown in FIG. 2 with the original content source 10, the devices 16 and the social media platform 14. The platform may further include a Generative Media engine 40 (that contains a portion of the extract unit 22, the analysis unit 24, the associate unit 26, the publishing unit 28 and the participatory unit 30 shown in FIG. 2) that includes an API wherein the IM users and partners can communicate with the engine 40 through the API. The devices 16 communicate with the API through a well known web server 42. A user manager unit 44 is coupled to the web server to store user data information and tune the contextual content being delivered to each user through the web server 42. The platform 14 may further include a data processing engine 46 that generates normalized data by channel (the channels are the different types of the original content) and the data is fed into the engine 40 that generates the contextual content and delivers it to the users. The data processing engine 46 has an API that receives data from a close captioning converter unit 48₁ (that analyzes the close captioning of the original content), a voice to text converter unit 48₂ (that converts the voice of the original content into text) so that the contextual search can be performed and an audio to text converter unit 48₃ (that converts the voice of the original content into text) so that the contextual search Can be performed wherein each of these units is part of the extract unit 22. The close captioning converter unit 48₁ may also perform filtering of “dirty” close captioning data such as close captioning data with misspellings, missing words, out of order words, grammatical issues, punctuation issues and the like.

The data processing engine 46 also receives input from a channel configurator 50 that configures the content for each different type of content. The data from the original content and the data processed by the data processing engine 46 are stored in a data storage unit 52 that may be a database. The database also stores the channel configuration information, content from the preauthoring tools (which is not in realtime) and search results from a search coordination engine 54 used for the contextual content. The search coordination engine 54 (part of the analysis unit 24 in FIG. 2) coordinates the one or more searches used to identify the contextual content wherein the searches may include a metasearch, a contextual search, a blog search and a podcast search.

FIGS. 4-6 illustrate an example of the user interface for an implementation of the Social Media Platform. For example, when a user goes to the system, the user interface shown in FIG. 4 may be displayed. In this user interface, a plurality of channels (such as Fox News, BBC News, CNN Breaking News) are shown wherein each channel displays content from the particular channel. It should be noted, that each of the channels may also be associated with one or more templates to present the secondary source data to the user. The templates may be automatically selected based on the broadcast on that channel, or may be manually selected by the user. The channel is one manner by which the user selects the primary content to which secondary content will be mapped.

Although the interface of FIG. 4 is illustrated as a plurality of available channels such as is consistent with the operation of a television, it should be understood that the interface can be configured by event or even type of event. For example, one tile could represent football with drill down possibilities to college or pro football, and drill down to all available games in each sport.

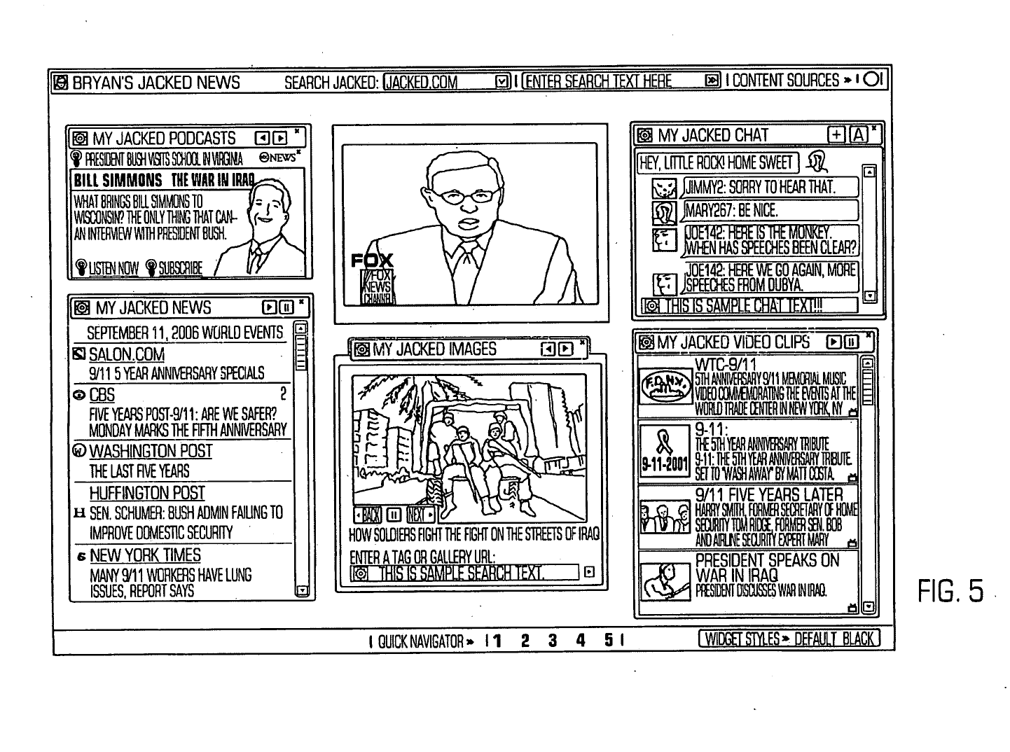

When a user selects the Fox News channel, the user interface shown in FIG. 5 is displayed to the user which has the Fox News content (the original content) in a window along with one or more contextual windows that display the contextual data that is related to what is being shown in the original content. In this example, the contextual data may include image slideshows, instant messaging content, RSS text feeds, podcasts/audio and video content. The contextual data shown in FIG. 5 is generated in real-time by the Generative Media engine 40 based on the original content capture and analysis so, that the contextual data is synchronized with the original content.

Tuning/Customization

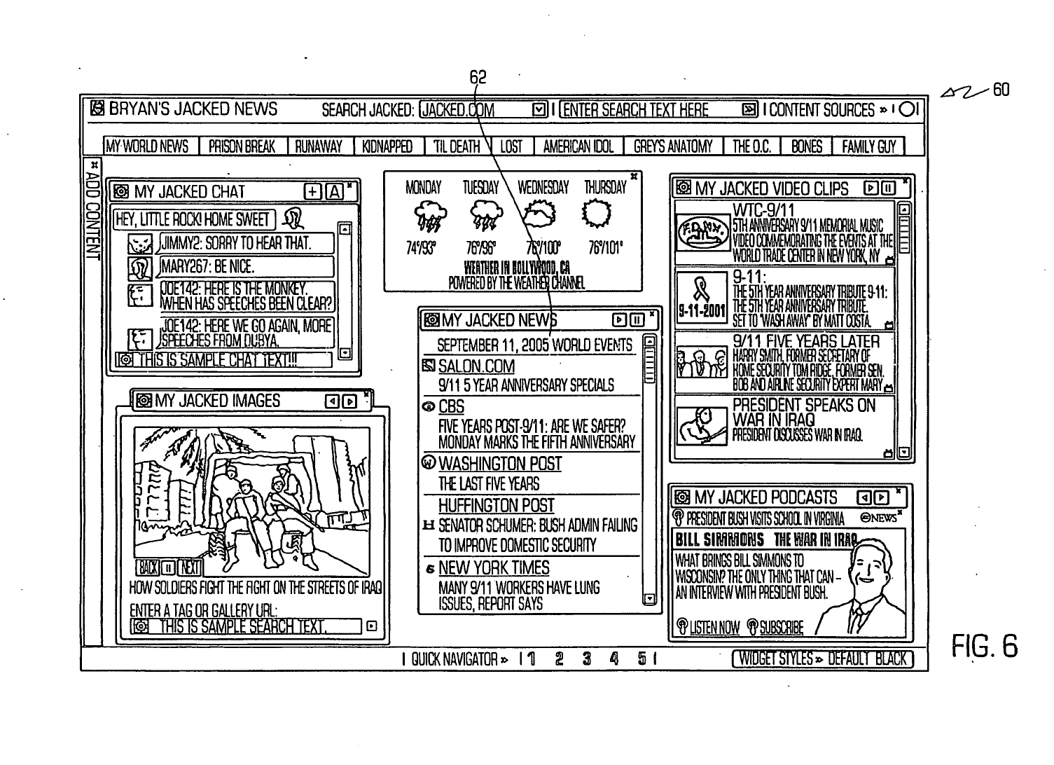

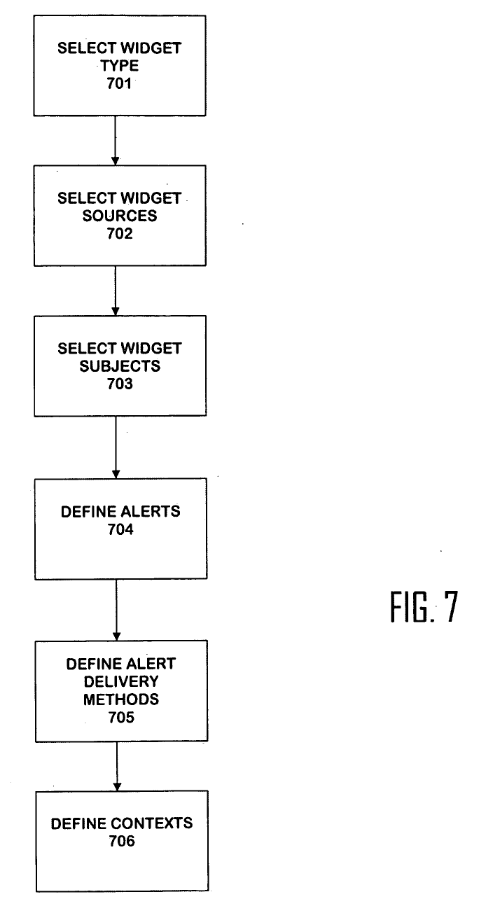

The present system provides for cosmetic and behaviour based tuning and customization of a dashboard that provides a plurality of content sources on a display dashboard. FIG. 6 is an example of a dashboard in an embodiment of the system. FIG. 6 is a block diagram of a plurality of widgets that can be used on a users desktop in an embodiment of the invention. In one embodiment of the system, the widgets can present independent and unrelated content. In another embodiment, the content of the widgets is tied to a primary content source and the widget content may be dynamically tied to triggers that are derived from the primary content source and the widget content sources.

The weather widget, for example, presents information that is not tied to triggers from the broadcast but is presenting weather information that is based on forecasting information from a weather service.

The video clip widget presents a dynamically changing selection of video clips that are trigger activated in one embodiment of the system. The video widget presents a list of available video clips that the user may choose to activate and watch as desired. The widget includes a scroll bar so that all of the offered video clips can be scanned and played independently of when they were offered for presentation. In one embodiment, when a trigger is detected, a search is undertaken for video that is relevant to the trigger. In some embodiments, all relevant video is offered. In other embodiments, the relevance is ranked pursuant to a relevance algorithm and only the first few are offered. In still other embodiments, only one clip is offered per trigger.

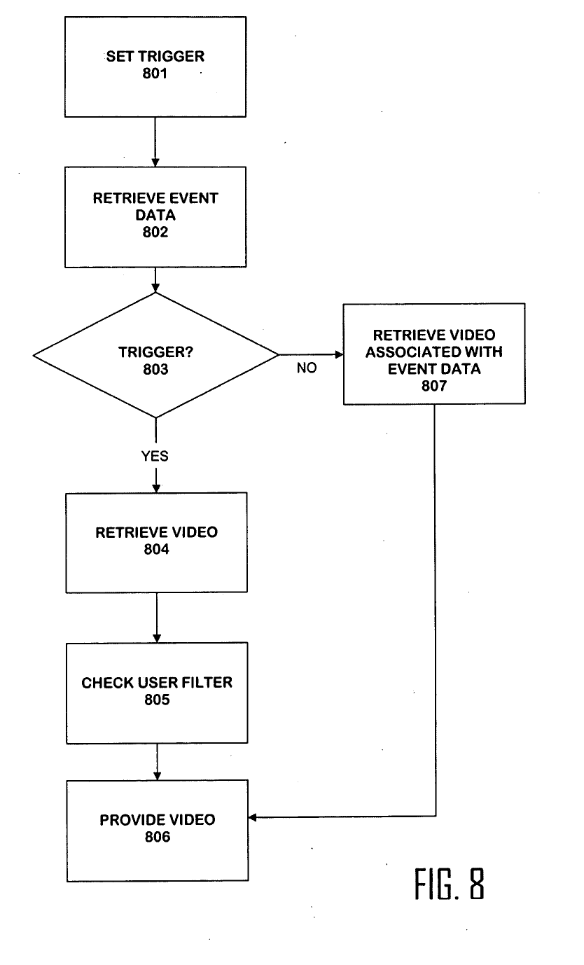

FIG. 8 is a flow diagram illustrating operation of the video widget in a trigger based environment. At step 801 the user defines a trigger associated with video content. The trigger may be an event in the primary broadcast (e.g. when his team scores), it may be time based, or it may be any other suitable detectable occurrence. At step 802 the system analyzes event parameters. At decision block 803 the system determines if one or more user defined triggers are present in the event parameters. If so, the system searches for and retrieves video content relevant to the trigger at step 804. At step 805 the system checks filter settings of the user (e.g. provide one video only, provide a fixed number, or provide all). At step 806 the system provides the video to the user pursuant to the filter settings.

If the event parameters do not include a trigger at step 803, the system optionally retrieves relevant video content related to the event parameters at step 807. These parameters may be provided via a statistical feed service, a play by play feed, parsing of closed captioning, or by any other suitable method of identifying event parameters.

A chat widget, such as is shown in FIG. 6, is typically trigger independent and is broadcast dependent only in the sense that the participating chatters are likely to be talking about things that are happening in the event broadcast. However, in one embodiment, the chat transcript can provide triggers to the other widgets. FIG. 6 also includes an image widget that displays a series of images based on triggers and a podcast widget that offers podcasts based on triggers. The widgets of FIG. 6 are merely an example of the possible widgets that can be used in the system.

In another embodiment, the system can also detect a context to determine update rates. For example, if the widgets are all related to an event, such as a sporting event, the time of game and the closeness of the game may indicate that a different update rate should be used. For example, at the end of a game, the user may be concentrating on the end game and not be interested in multiple widgets, necessitating a lower update rate on certain widgets.

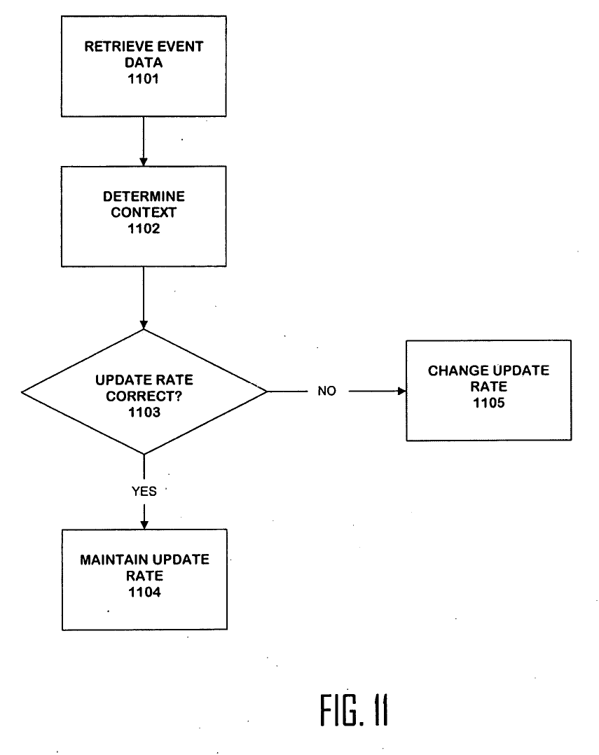

FIG. 11 is a flow diagram illustrating the modification of update rates pursuant to an embodiment of the system. At step 1101 the system retrieves event data. At step 1102 the system analyzes the event data to determine if a context exists that will affect widget update rate. For example, the system may check the time remaining, the score, the closeness of one team or another to scoring, etc. At decision block 1103, the system determines if the current update rate is appropriate for the present context. If so, at step 1104 the system maintains the current update rate. If not, the system changes the update rate (either up or down) as appropriate for the current context at step 1105

The system allows the user to choose the secondary content source for each widget. For example, the news widget could be tied to CNN, FoxNews, network or local news feeds, the BBC, FNN, or any other desired news feed. Similarly, the image widget could be coupled to Flickr, Corbis, Google images, Yahoo images, or any other image source. The video widget could be tied to news sites, YouTube, or other video providers.

In some cases, the secondary content is coordinated with and synchronized with a primary content broadcast. However, the present system permits the user to tie any one or more widgets to any other primary content source as desired. For example, if the user has the secondary content sources coordinated with a sporting event, the user can set one or more widgets to be synchronized to a completely different sporting event. This provides more than just scores and updates of another game, it can provide secondary content of interest, allowing the user to follow multiple events as desired.

The system can also take advantage of a feature referred to as “alerts”. The system allows the user to focus on information of interest and a widget can be programmed to update or alert the user when certain things occur. For example, the user may be watching an awards show but is only interested in certain categories. The system can track the close captioning from the awards show and alert the user when the category of interest is on so the user can access the broadcast as desired. The system in effect is watching TV on the user's behalf. This can all take place while the dashboard is coordinated, with a completely different broadcast.

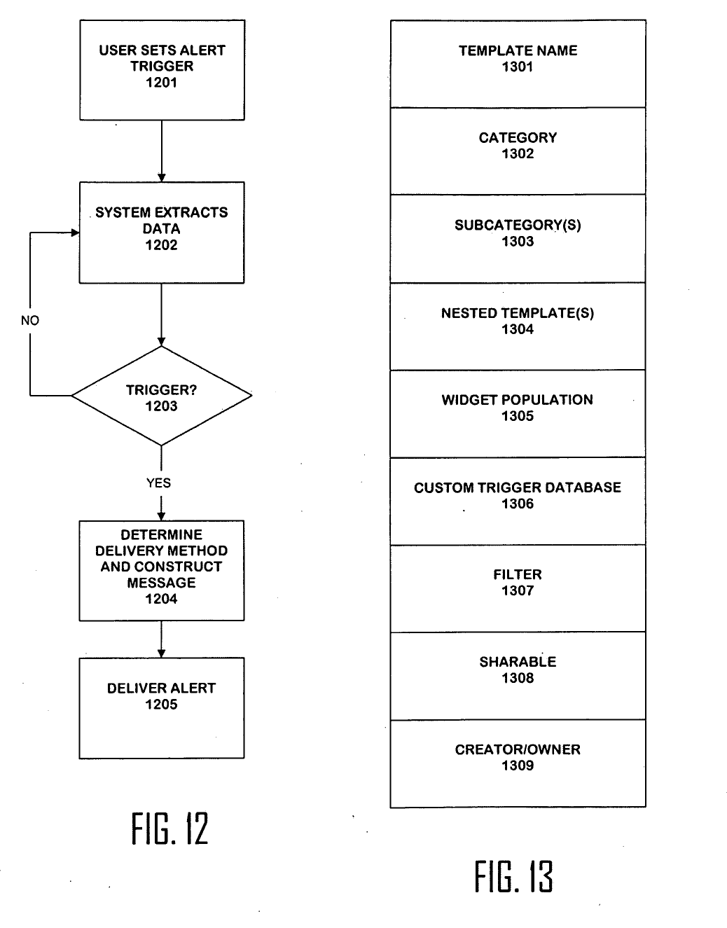

FIG. 12 is a flow diagram illustrating the operation of alerts in one embodiment of the system. At step 1201 a user defines an alert trigger and a delivery method for receiving the alert. The alert trigger may be the presence of one or more players in a game, the performance of some event by one or more players, the mention of a player or team in a content source, the updating of a content source, or any other detectable event. It should be noted that alert triggers may be independent of a primary broadcast event or primary content source in the system. A user may be watching one game but desire to be notified of actions related to other players or teams that are not part of the primary broadcast event that the user is currently watching.

At step 1202 the system monitors one or more content sources and extracts data as described above. At step 1203 the system determines if any of the extracted data matches a trigger for the user. If so, the system checks the user settings at step 1204 to determine what delivery method or methods is to be used for this particular trigger. In some cases the user may want an onscreen alert, while in other cases the user may desire a text message, a phone call, an email, or some other suitable notification method. At step 1205 the system delivers the alert pursuant to the user settings.

Similarly, the system can be set to provide alerts for certain contexts. For example, the user may only want to know when an event is near the end, such as a sporting event. The system can track metadata from a sporting event to determine when the event is nearing its completion and alert the user. The user may also want to be alerted when his favourite team has scored or is leading a sporting event. These alerts can be set as well.

The system can also be tied to alerts to notify a user when other users of the system are active. The system may offer an alert that includes the possibility of offering to present a duplicate of the other user's dashboard to the alerted user.

The system allows a user to save a plurality of particular dashboard layouts that can be per sport, per level, per team. The system allows the user to save each dashboard layout as a template and publish the template to a gallery to permit others to access and use for their own dashboards.

The Social Media Platform implements a user interface that is defined by a number of parameters referred to herein as a “template”. A template is one embodiment of the user interface that presents content to the user that is synchronized with a broadcast. A template comprises triggers, sources, widgets, and filters which are described in more detail below.

The system contemplates an environment of use with a number of different types of broadcasts, including multiple sports broadcasts, reality television, live events, game shows, television series, news, and any other type of broadcast. The system permits the user to generate templates to customize the user experience depending on the type of program presented. This can be true even when events are in the same sport. For example, a user may prefer a different interface for professional football than the user has for college football. Further, the user may have a specific template when the user's favorite team is playing versus games when other non-favorite teams are playing.

The templates can be saved by the user and set to be employed automatically based on the event being broadcast. Because the templates can be saved, the templates can also be published and shared by users participating in the system. A preferred template might be found for a favorite team that can then be shared among similarly minded fans so that the fan's experience can be improved. In addition, the users of a particular shared template can be defined as a mini-network of users and additional interaction among this mini-network can be provided that might otherwise not be possible. In one instance, this can take the form of real time un-moderated chatting during a game, so that fans can share highlights and lowlights via chat messages. This charting allows fans to provide additional information to other fans that might not be available from the broadcast or the announcers.

The templates can be nested as desired so that, for example, the user can define a general template that is suitable for all football games. A second nested template can be defined for when it is a professional football game. A third nested template can be defined for when the user's favorite team is playing. These templates can be manually selected by the user in advance of a broadcast event or may include filters so that they are triggered and employed automatically when the user logs on to a broadcast.

### Template Structure

FIG. 13 is a block diagram of one embodiment of a template structure of the system. The template includes a name 1301. Next the template includes a category 1302 and one or more nested subcategories 1303. For example the category could be sports, a subcategory could be football, and two more subcategories could be pro football and college football. A nested template block 1304 includes the names of one or more templates that are referred to and inform the present template. For example, there might be a football template, a college football template, a favorite team template, and a favorite player template that can all be nested to generate a new template. These nested templates can be used in lieu of, or in cooperation with, the categories and subcategories.

The template also includes a listing 1305 of one or more widgets that are to be part of the template. A custom trigger database 1306 is used to enable the user to add custom triggers or keywords to be used with this particular template. A filter 1307 provides the data about filters that are to be used with the template. These filters can be specific or can be conditionally rule based, such as “when my favorite team is playing, filter out the opposing team” or “always filter out Michigan information”.

Region 1308 is used to indicate whether the template is to be sharable or not and region 1309 can be used to indicate the owner or creator of the template.

As noted above, the templates can be shared between users. The templates can be published as well. In some cases, it is contemplated that third parties will create and promote templates for events that can be downloaded and used by a plurality of users. For example, a fan club of a show may generate a template to be offered for use by other fans of the shown. In some cases, there may be features of the template that are only available to users of the template. For example, there may be a chat feature that is only activated for users of the template. This allows the system to provide a unique shared experience among users for a broadcast event.

Commercial entities may create and promote templates that include advertising widgets promoting the commercial entity. Some companies may want to include game widgets or contest widgets that encourage user participation during an event broadcast with the chance for some prize or premium for success in the contest.

The activity of the template during an event is stored in a database so that the template can be replayed or searched after the completion of the broadcast. This also encourages sharing of templates. If a user had a particularly good experience during a broadcast, that user may want to share their template with other users.

The template, widgets, and dashboard layouts can all be exported to other environments.

One example is a statistical widget configured to provide certain data for a player, team, or other entity. That widget could be exported for use to another environment that could take advantage of the widget tied to secondary content sources and be used independently of coordination with a primary content source. A user can tunably choose specific players and specific data fields for a player and type of statistic that the user desires.

Widgets can also be tuned by team for example so that each widget (news, video, images, etc.) will only show information associated with that specific team.

The system can tune news sources (e.g. rss feeds) in a widget so that a news finding widget can define the source of news as well as filtering it for a specific type of content. So each type of widget can be selected and each widget can be custom tuned to the user specifications.

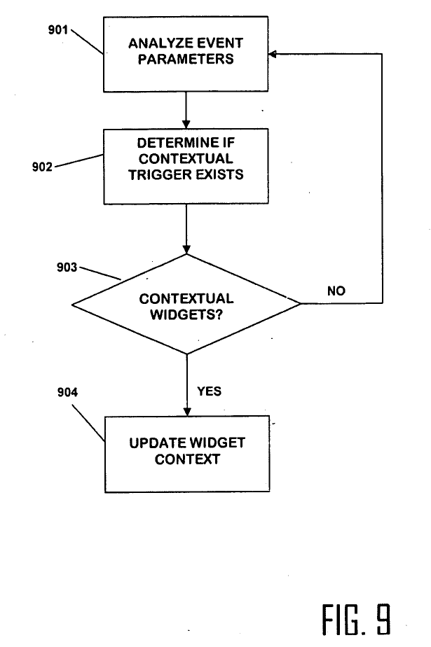

Contextual triggers are based on situations and temporal events associated with the event and can also be used as triggers to update widgets. FIG. 9 is a flow diagram illustrating the operation of contextual widgets. At step 901 the event is analyzed for contextual data. In a game event, this could consist of the score of the game, including the amount by which one team is winning or losing, the time of the game (early or late, near halftime, final two minutes, etc.), the location of the present game or the next game for the user's favorite team, the weather, and the like. At step 902 the system analyzes the data and determines if a contextual trigger exists.

A contextual trigger may be different from other triggers in that it may exist for an extended period of time. In some embodiments, the contextual trigger is used to shade or influence the updates of widgets based on more instantaneous and realtime triggers. At decision block 903 the system checks to see if there are any widgets that can be affected by the contextual trigger. If no, the system returns to step 901. If yes, the system proceeds to step 904 and modifies the widgets so that widget updates reflect the presence of the contextual trigger.

In one embodiment, the contextual triggers react to game situations to influence the activity and output of widgets. For example, if the user's favorite team is winning easily, the user may be very enthusiastic about his team. In that case, the contextual trigger could cause the display of travel advertisements, particularly those directed to attending the next game of the user's favorite team. The contextual trigger could also cause widgets to display other information about the city in which the team has its next game (whether home or away) to further encourage travel or attendance by the user. When the favorite team is losing badly, the contextual trigger may cause a widget or widgets to display historical data of more successful moments of the team so that the user can stay interested in observing the system and not so discouraged that the user will end the viewing session. For example, the system could be triggered to display successful comebacks by the favorite team from earlier games or seasons, reminding the user of the possibility of a turnaround.

A widget may also be implemented as a container for other widgets. In this case the widgets will perform in a manner similar to object oriented programming containers and objects. A widget may specify a data source and that data source may be another widget. In addition, the display characteristics for a widget may be provided by another widget. In this manner, a user can customize more easily by, for example, defining a single display format widget and then referencing it in other custom or standard widgets.

Branding

The system contemplates the ability of third parties to provide widgets for users. In one embodiment, the widgets are sponsored and are provided by commercial entities such as advertisers. In other instances, each widget contains a field for sponsorship and the system is enabled to place a sponsors name in the sponsor field of the widget. This may be for an entire game or may change during the game. The change may be time based or context based. In one embodiment, a sponsor contracts to appear in the sponsor field only when the user's team is winning. Because users are registered and can indicate which team they are rooting for, the sponsor has the ability to only show the brand to those users whose team is winning. In other words, two people could watch a game and whichever team is ahead, the user for that team will see a sponsor in the sponsor field of the widgets while the other user would not.

In other instances, the sponsor can determine which widget the sponsor wishes to advertise in. In addition, the sponsor could use context to determine what type of advertisement or presentation to have associated with one or more widgets. This would be a context trigger and would operate in a similar manner to the context and other trigger described above.

Example Computer System

Embodiment of Computer Execution Environment (Hardware)

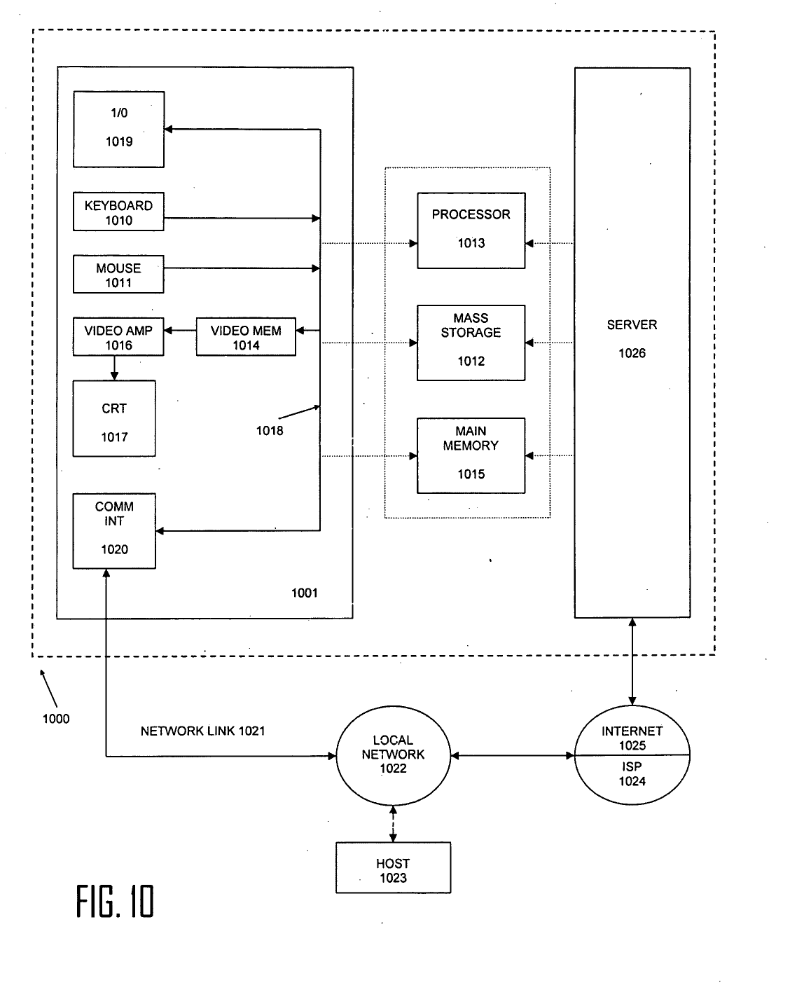

An embodiment of the system can be implemented as computer software in the form of computer readable program code executed in a general purpose computing environment such as environment 1000 illustrated in FIG. 10, or in the form of bytecode Class files executable within a Java.TM. run time environment running in such an environment, or in the form of bytecodes running on a processor (or devices enabled to process bytecodes) existing in a distributed environment (e.g., one or more processors on a network). A keyboard 1010 and mouse 1011 are coupled to a system bus 1018. The keyboard and mouse are for introducing user input to the computer system and communicating that user input to central processing unit (CPU 1013. Other suitable input devices may be used in addition to, or in place of, the mouse 1011 and keyboard 1010. I/O (input/output) unit 1019 coupled to bi-directional system bus 1018 represents such I/O elements as a printer, A/V (audio/video) I/O, etc.

Computer 1001 may include a communication interface 1020 coupled to bus 1018. Communication interface 1020 provides a two-way data communication coupling via a network link 1021 to a local network 1022. For example, if communication interface 1020 is an integrated services digital network (ISDN) card or a modem, communication interface 1020 provides a data communication connection to the corresponding type of telephone line, which comprises part of network link 1021. If communication interface 1020 is a local area network (LAN) card, communication interface 1020 provides a data communication connection via network link 1021 to a compatible LAN. Wireless links are also possible. In any such implementation, communication interface 1020 sends and receives electrical, electromagnetic or optical signals which carry digital data streams representing various types of information.

Network link 1021 typically provides data communication through one or more networks to other data devices. For example, network link 1021 may provide a connection through local network 1022 to local server computer 1023 or to data equipment operated by ISP 1024. ISP 1024 in turn provides data communication services through the world wide packet data communication network now commonly referred to as the “Internet” 1025. Local network 1022 and Internet 1025 both use electrical, electromagnetic or optical signals which carry digital data streams. The signals through the various networks and the signals on network link 1021 and through communication interface 1020, which carry the digital data to and from computer 1000, are exemplary forms of carrier waves transporting the information.

Processor 1013 may reside wholly on client computer 1001 or wholly on server 1026 or processor 1013 may have its computational power distributed between computer 1001 and server 1026. Server 1026 symbolically is represented in FIG. 10 as one unit, but server 1026 can also be distributed between multiple “tiers”. In one embodiment, server 1026 comprises a middle and back tier where application logic executes in the middle tier and persistent data is obtained in the back tier. In the case where processor 1013 resides wholly on server 1026, the results of the computations performed by processor 1013 are transmitted to computer 1001 via Internet 1025, Internet Service Provider (ISP) 1024, local network 1022 and communication interface 1020. In this way, computer 1001 is able to display the results of the computation to a user in the form of output.

Computer 1001 includes a video memory 1014, main memory 1015 and mass storage 1012, all coupled to bi-directional system bus 1018 along with keyboard 1010, mouse 1011 and processor 1013.

As with processor 1013, in various computing environments, main memory 1015 and mass storage 1012, can reside wholly on server 1026 or computer 1001, or they may be distributed between the two. Examples of systems where processor 1013, main memory 1015, and mass storage 1012 are distributed between computer 1001 and server 1026 include the thin-client computing architecture developed by Sun Microsystems, Inc., the palm pilot computing device and other personal digital assistants, Internet ready cellular phones and other Internet computing devices, and in platform independent computing environments, such as those which utilize the Java technologies also developed by Sun Microsystems, Inc.

The mass storage 1012 may include both fixed and removable media, such as magnetic, optical or magnetic optical storage systems or any other available mass storage technology. Bits 1018 may contain, for example, thirty-two address lines for addressing video memory 1014 or main memory 1015. The system bus 1018 also includes, for example, a 32-bit data bus for transferring data between and among the components, such as processor 1013, main memory 1015, video memory 1014 and mass storage 1012. Alternatively, multiplex data/address lines may be used instead of separate data and address lines.

In one embodiment of the invention, the processor 1013 is a microprocessor such as manufactured by Intel, AMD, Sun, etc. However, any other suitable microprocessor or microcomputer may be utilized. Main memory 1015 is comprised of dynamic random access memory (DRAM). Video memory 1014 is a dual-ported video random access memory. One port of the video memory 1014 is coupled to video amplifier 1016. The video amplifier 1016 is used to drive the cathode ray tube (CRT) raster monitor 1017. Video amplifier 1016 is well known in the art and may be implemented by any suitable apparatus. This circuitry converts pixel data stored in video memory 1014 to a raster signal suitable for use by monitor 1017. Monitor 1017 is a type of monitor suitable for displaying graphic images.

Computer 1001 can send messages and receive data, including program code, through the network(s), network link 1021, and communication interface 1020. In the Internet example, remote server computer 1026 might transmit a requested code for an application program through Internet 1025, ISP 1024, local network 1022 and communication interface 1020. The received code maybe executed by processor 1013 as it is received, and/or stored in mass storage 1012, or other non-volatile storage for later execution. In this manner, computer 1000 may obtain application code in the form of a carrier wave. Alternatively, remote server computer 1026 may execute applications using processor 1013, and utilize mass storage 1012, and/or video memory 1015. The results of the execution at server 1026 are then transmitted through Internet 1025, ISP 1024, local network 1022 and communication interface 1020. In this example, computer 1001 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. An embodiment of the invention may be implemented in any type of computer system or programming or processing environment.

What is claimed is:

1. A method for defining a presentation widget comprising:
selecting a type of widget from a plurality of widgets;
selecting one or more content sources for the widget;
defining one or more subjects for the widget.

2. The method of claim 1 further including the step of setting an alert in the widget to contact a user on the occurrence of a trigger.

3. The method of claim 1 further including the step of associating the widget with a primary content broadcast.

4. The method of claim 3 further including the step of presenting content on the widget from a secondary source.

5. The method of claim 4 further wherein the secondary content is associated with primary content.

6. The method of claim 1 wherein the subject of the widget is a component of the primary content broadcast.

7. The method of claim 3 further including the step of providing a display region of the widget for displaying advertising materials.

8. The method of claim 7 wherein the advertising materials that are displayed are dependent on a context of the primary content broadcast.

9. The method of claim 2 wherein the alert has a trigger associated with a primary content broadcast.

10. The method of claim 9 wherein the alert has a trigger that is not associated with the primary content broadcast.
